(19) United States
(12) Patent Application Publication
(10) Pub. No.: US 2017/0163791 A1
(43) Pub. Date: Jun. 8, 2017

(54) METHOD AND DEVICE FOR MESSAGE PROMPTING

(71) Applicant: BOE TECHNOLOGY GROUP CO., LTD., Beijing (CN)

(72) Inventor: Chuxiong ZHANG, Beijing (CN)

(73) Assignee: BOE TECHNOLOGY GROUP CO., LTD., Beijing (CN)

(21) Appl. No.: 15/025,123

(22) PCT Filed: Sep. 17, 2015
(86) PCT No.: PCT/CN2015/089879

§ 371 Date: Mar. 25, 2016

(30) Foreign Application Priority Data
May 19, 2015 (CN) 201510257906.6

(51) Int. Cl. H04M 1/725; H04L 12/58

(52) U.S. Cl. CPC H04M 1/72552; H04L 51/22; H04M 1/72583; H04L 51/02; H04M 1/72577

(57) ABSTRACT

A method and a device for message prompting are provided. The method includes: receiving a dialling instruction inputted by a calling user for establishing a voice communication, and determining, based on the received dialling instruction, an identity of a called user to perform the voice communication; judging whether a message corresponding to the identity of the called user to perform the voice communication is included in an unread message; and displaying prompt information if it is judged that the message corresponding to the identity of the called user to perform the voice communication is included in the unread message.

### CROSS-REFERENCE TO RELATED APPLICATION

The present application claims the priority to Chinese patent application No. 201510257906.6 filed on May 19, 2015, which is incorporated herein by reference in its entirety.

### TECHNICAL FIELD

The disclosure relates to the field of communications, and in particular to a method and a device for message prompting.

### BACKGROUND

With the continuous development of communications technology, mobile communication terminals such as personal digital assistants and tablet computers, etc., have become essential communication contact tools in lives of users. It is convenient and economical in using the mobile communication terminals to receive and send messages. Therefore, the messaging functionality of the mobile communication terminals is used by more and more users.

Typically, users may use mobile terminals for voice communications. A side initiating a voice communication is referred to as a calling user and a side receiving the voice communication is referred to as a called user. Instant communications tools may be arranged in the mobile communication terminals and messages may be received and sent by the arranged instant communication tools, or messages may be received and sent by the mobile communication terminals themselves. The received or sent messages may include one or any combination of image information, text information, audio information and video information.

If it is desirable to receive a message via an instant communication tool arranged in a mobile communication terminal, an identity is required to set in the instant communication tool, the identity may be a user identity or a terminal identity. Take a case of receiving a short message by the mobile communication terminal as an example, upon the reception of a short message, the mobile communication terminal may prompt a user that the message has been received with a short message prompting manner already set in the mobile communication terminal. However, in this way, the user often easily ignore the received short message even though the short message needs to be promptly viewed, and if it is inconvenient for both sides to perform voice communication, the message will not be viewed until it is convenient for the message receiver. In addition, since the received message is not viewed by the message receiver in time, the message receiver may contact with a message sender via voice communication. Hence, unnecessary voice communication between the message sender and the message receiver is performed, which occupies network resources and wastes cost.

From the foregoing, in general, in a case that messages are transmitted via the mobile communication terminals, unnecessary voice communication may be performed between the message sender and the message receiver, which occupies network resources and wastes cost.

### SUMMARY

A method and a device for message prompting are provided in the present disclosure, for avoiding unnecessary voice communications between a message sender and a message receiver and saving network resources and the cost.

According to an embodiment of the present disclosure, a method for message prompting is provided, which includes: receiving a dialling instruction inputted by a calling user for establishing a voice communication, and determining, based on the received dialling instruction, an identity of a called user to perform the voice communication; judging whether a message corresponding to the identity of the called user to perform the voice communication is included in an unread message; and displaying prompt information, when it is judged that the message corresponding to the identity of the called user to perform the voice communication is included in the unread message.

In an alternative implementation, before the step of receiving a dialling instruction inputted by a calling user for establishing a voice communication, the method further includes: judging whether an information prompting function for the unread message is enabled.

In an alternative implementation, after the step of displaying prompt information, the method further includes: receiving an operation instruction sent by the calling user.

In an alternative implementation, the operation instruction may include a message reading instruction; and the method for message prompting may further include: concealing the prompt information upon reception of the message reading instruction, and displaying the unread message to the calling user.

In an alternative implementation, the operation instruction may include a dialling continuing instruction; and the method for message prompting may further include: executing the dialling instruction to establish the voice communication upon reception of the dialling continuing instruction.

In an alternative implementation, the operation instruction may include a dialling abandoning instruction; and the method for message prompting may further include: concealing the prompt message upon reception of the dialling abandoning instruction.

In an alternative implementation, the operation instruction may include a message replying instruction; and the method for message prompting may further include: displaying an operation interface for message replying upon reception of the message replying instruction.

According to another embodiment of the present disclosure, a device for message prompting is provided, which includes: a determining module, used to receive a dialling instruction inputted by a calling user for establishing a voice communication, and determine, based on the received dialling instruction, an identity of a called user to perform the voice communication; a judging module, used to judge whether a message corresponding to the identity of the called user to perform the voice communication is included in an unread message; and an executing module, used to display prompt information when the judging module judges that the message corresponding to the identity of the called user to perform the voice communication is included in the unread message.

In an alternative implementation, the judging module may be further used to judge whether an information prompting function for the unread message is enabled.

In an alternative implementation, the device for message prompting may further include a receiving module, which is used to receive an operation instruction sent by the calling user.

In an alternative implementation, the operation instruction may include a message reading instruction; and the executing module may be further used to: conceal the prompt information upon reception of the message reading instruction, and display the unread message to the calling user.

In an alternative implementation, the operation instruction may include a dialling continuing instruction; and the executing module may be further used to execute the dialling instruction to establish the voice communication upon reception of the dialling continuing instruction.

In an alternative implementation, the operation instruction may include a dialling abandoning instruction, and the executing module may be further used to conceal the prompt information upon reception of the dialling abandoning instruction.

In an alternative implementation, the operation instruction may include a message replying instruction; and the executing module may be further used to display an operation interface for message replying upon reception of the message replying instruction.

According to another embodiment of the present disclosure, a device for message prompting is provided, which includes: one or more processors and a storage medium which stores therein computer-readable operation instructions. The computer-readable operation instructions, when being executed by the one or more processors, cause the one or more processors to: receive a dialling instruction inputted by a calling user for establishing a voice communication, and determine, based on the received dialling instruction, an identity of a called user to perform the voice communication; judge whether a message corresponding to the identity of the called user to perform the voice communication is included in an unread message; and display prompt information when it is judged that the message corresponding to the identity of the called user to perform the voice communication is included in the unread message.

In an alternative implementation, the computer-executable instructions, when being executed, cause the one or more processors to: judge whether an information prompting function for the unread message is enabled.

In an alternative implementation, the computer-executable instructions, When being executed, cause the one or more processors to: receive an operation instruction sent by the calling user.

In an alternative implementation, the operation instruction may include a message reading instruction; and the computer-executable instructions, when being executed, cause the one or more processors to: conceal the prompt information upon reception of the message reading instruction and display the unread message to the calling user.

In an alternative implementation, the operation instruction may include a dialling continuing instruction; and the computer-executable instructions, when being executed, cause the one or more processors to: execute the dialling instruction to establish the voice communication upon reception of the dialling continuing instruction.

In an alternative implementation, the operation instruction may include a dialling abandoning instruction; and the computer-executable instructions, when being executed, cause the one or more processors to: conceal the prompt information upon reception of the dialling abandoning instruction.

In an alternative implementation, the operation instruction may include a message replying instruction; and the computer-executable instructions, when being executed, cause the one or more processors to: display an operation interface for message replying upon reception of the message replying instruction.

With the technical solutions in the embodiments of the present disclosure, an identity of a message sender to perform a voice communication is determined when a dialling instruction for establishing the voice communication is received from a calling user; it is judged whether a message corresponding to the identity is included in an unread message; and prompt information for the unread message is displayed when it is judged that the message corresponding to the identity is included in the unread message. Therefore, a message receiver may determine that the corresponding message is included in the unread message and may display the prompt information for the unread message before a voice communication is established between the message receiver and the message sender. The message receiver may perform a next operation according to the prompt information, thus, unnecessary voice communication between a message sender and a message receiver is avoided, thereby saving network resources saving and the cost.

### BRIEF DESCRIPTION OF THE DRAWINGS

FIG. 1 is a flowchart of a method for message prompting according to an embodiment of the present disclosure;

FIG. 2 is flowchart of a method for message prompting according to an embodiment of the present disclosure;

FIG. 3 is schematic structural diagram of a device for message prompting according to an embodiment of the present disclosure;

FIG. 4 is schematic structural diagram of a device for message prompting according to an embodiment of the present disclosure.

### DETAILED DESCRIPTION OF THE EMBODIMENTS

An implementation principle, specific implementations and achievable beneficial effects of technical solutions of embodiments of the present disclosure are described below in detail, in conjunction with accompanying drawings used in the present disclosure.

In technical solutions in the embodiments of the present disclosure, message prompting may include short message prompting and multimedia message prompting. The technical solutions in the embodiments of the present disclosure can be applied to an instant communication tool arranged in a mobile communication terminal.

Specifically, if the technical solutions in the present disclosure are applied to an instant communication tool, the instant communication tool is firstly logged in via a user identity (for example, a user name and a password) and then is kept in an online status. The instant communication tool running in the background is also regarded as in the online status.

In the technical solutions in the embodiments of the present disclosure, a message may include one of text information, multimedia information, image information, an audio clip and a video clip, or any combination thereof, which is not limited specifically here.

For purpose of illustration, in the technical solutions in the embodiments of the present disclosure, for two sides performing a voice communications process, a side initiating a voice call is referred to as a calling user and a side receiving the voice call is referred to as a called user.

Specifically, for purpose of illustration, in the technical solutions in the present disclosure, the calling user and the message receiver are the same, and the called user and the message sender are the same.

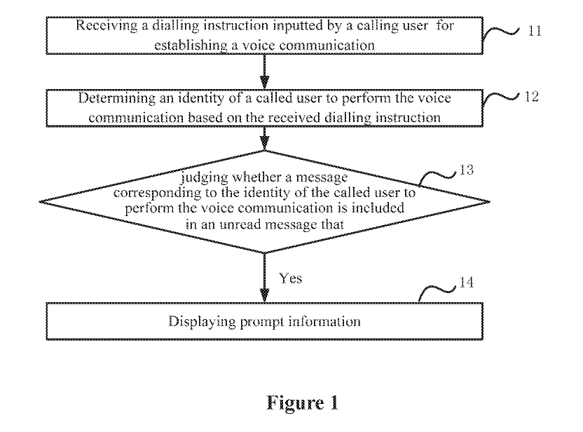

In an alternative implementation of the technical solutions in the present disclosure, short message prompting for a mobile communication terminal is taken as an example for detail illustration. A method for message prompting is provided according to an embodiment of the present disclosure, as shown in FIG. 1, the method for message prompting includes following steps 11 to 15.

In step 11, a dialling instruction for establishing a voice communication is received.

A dialling instruction, which is inputted by a calling user for establishing a voice communication, is received. The dialling instruction includes an identity of a called user to perform the voice communication.

The identity of the called user to perform the voice communication may be a Subscriber identity Module (SIM) number of the called user, an instant communication number, or a part of the SIM number, etc., which is not limited specifically here.

In step 12, the identity of the called user to perform the voice communication is determined based on the received dialling instruction.

In step 13, it is judged whether a message corresponding to the identity of the called user to perform the voice communication is included in an unread message. Step 14 is performed when it is judged that the message corresponding to the identity of the called user to perform the voice communication is included in the unread message, or else step 15 is performed.

In step 14, prompt information for the unread message is displayed, Here, no voice communication is established between the calling user and the called user.

The prompt information may be a text or an audio, which is not limited specifically here.

In step 15, the dialling instruction is executed, and the voice communication is established between the calling user and the called user.

In the method for message prompting according to the embodiment of the present disclosure, an identity of a called user to perform a voice communication is determined when a dialling instruction for establishing the voice communication is received. It is judged, based on the determined identity, whether a message corresponding to the identity is included in an unread message; and prompt information for the unread message is displayed when it is judged that the message corresponding to the identity is included in the unread message. With the method for message prompting in the embodiment of the present disclosure, if a message from a message sender is not viewed in time by a message receiver, the message receiver may input an identity of the message sender, such as a SIM number, before a voice communication is established between the message receiver and the message sender. A mobile communication terminal may receive the inputted SIM number and may determine whether a message corresponding to the SIM number is included in an unread message. The mobile communication terminal displays prompt information for the unread message if the message corresponding to the SIM number is included in the unread message, and the message receiver may proceed to subsequent operations according to the prompt information. Thus, unnecessary voice communication between the message sender and the message receiver is avoided, thereby saving network resources and the cost.

Specifically, if the method for message prompting in the embodiment of the present disclosure is applied to an instant communication tool in a mobile communication terminal, the instant communication tool needs to access a contact list in the mobile communication terminal to obtain the user identity, or the user identity is stored in the instant communication tool.

Specifically, according to the method for message prompting in the embodiment of the present disclosure, before performing the step 11 of receiving the dialling instruction for establishing the voice communication, the method further includes step 10 and step 20.

In step 10, it is judged whether an information prompting function for an unread message is enabled, and step 20 is performed when it is judged that the information prompting function for the unread message is not enabled, or else step 11 is performed.

in step 20, it is determined whether the information prompting function is needed to be enabled, and the prompt information is set to be displayed if it is determined that the information prompting function is needed to be enabled.

Specifically, in step 10 and step 20, there may be several ways for determining whether the information prompting function is needed to be enabled. In one way, whether the prompt information is needed to be displayed is determined based on an instruction inputted by a user; and the information prompting function may be enabled in advance if the user wants the prompt information to be displayed. In another way, when it is judged that the information prompting function is not enabled, that is, it is not permitted to display the prompt information, the user may be prompted to turn on the information prompting function and then step 11 is performed. For example, when it is judged that the information prompting function is not enabled, the information prompting function is enabled, and then step 11 is performed.

In the method for message prompting according to the embodiment of the present disclosure, when implementing step 20, if it is determined that the information prompting function for the unread message is needed to be enabled, the information prompting function may be enabled manually, and if it is determined that the information prompting function for the unread message is not needed to be enabled, step 15 is performed, that is, the dialling instruction is executed and the voice communication is established.

Specifically, in the method for message prompting according to the embodiment of the present disclosure, the prompt information displayed to the user may be a part of or whole of the content of the unread short message.

In the method for message prompting according to the embodiment of the present disclosure, after perforating the step 14 of displaying the prompt information for the unread message, the method further includes step 30: receiving an operation instruction sent by the calling user.

Specifically, the operation instruction may include at least one of: a message reading instruction, a dialling continuing instruction, a dialling abandoning instruction, and a message replying instruction and the like.

Specifically, if the operation instruction is a message reading instruction, step 31 is performed.

In step 31, when the message reading instruction is received, the prompt information is concealed and the unread message is displayed to the calling user.

Specifically, if the operation instruction is a dialling continuing instruction, step 32 is performed.

In step 32, when the dialling continuing instruction is received, a voice communication is established based on the dialling instruction.

Optionally, when the dialling continuing instruction is received, the prompt information for the unread message is firstly concealed and then a voice communication is performed. Thus, processing resources may be better saved, and the user experience is improved.

Specifically, the operation instruction may be a combination of the message reading instruction and the dialling continuing instruction. That is, the dialling continuing instruction may be inputted after the inputting of the message reading instruction. In this manner a voice communication is established based on the dialling instruction after the unread message is displayed,

Specifically, if the operation instruction is a dialling abandoning instruction, step 33 is performed.

In step 33, when the dialling abandoning instruction is received, the prompt information is concealed.

Optionally, when the prompt information is concealed, the unread message may be displayed to the calling user.

Specifically, the operation instruction may be a combination of the message reading instruction and the dialling abandoning instruction, the order of which is not limited, the message reading instruction may be prior to the dialling abandoning instruction, or the dialling abandoning instruction may be prior to the message reading instruction.

Specifically, if the operation instruction is a message replying instruction, step 34 is performed.

In step 34, When the message replying instruction is received, an operation interface for message replying is displayed.

Optionally, When the message replying instruction is received, the prompt information may be concealed.

Specifically, the operation instruction may be a combination of the message replying instruction and the message reading instruction, a combination of the message replying instruction and the dialling continuing instruction, or a combination of the message replying instruction and the dialling abandoning instruction.

With the above manners, flexibility of user operations and user experience play be improved.

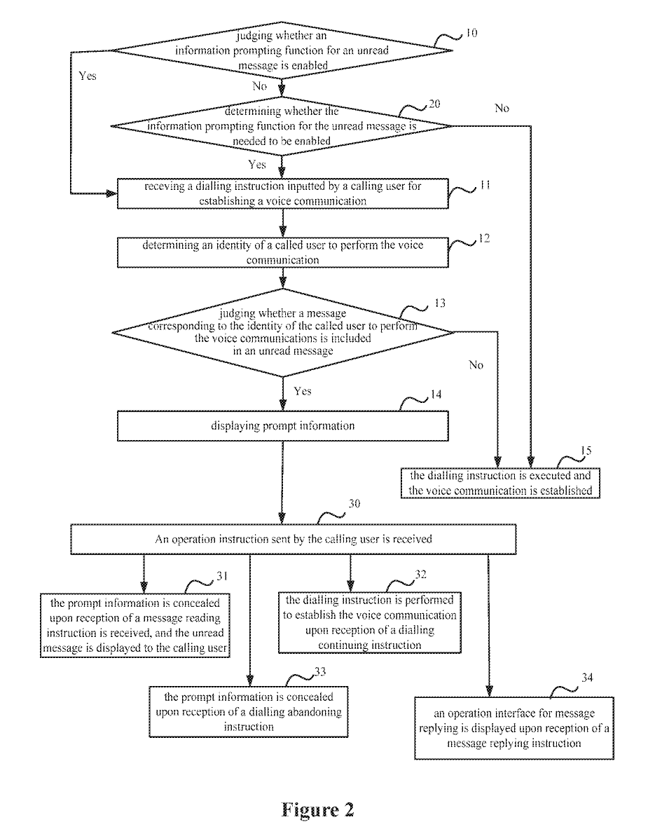

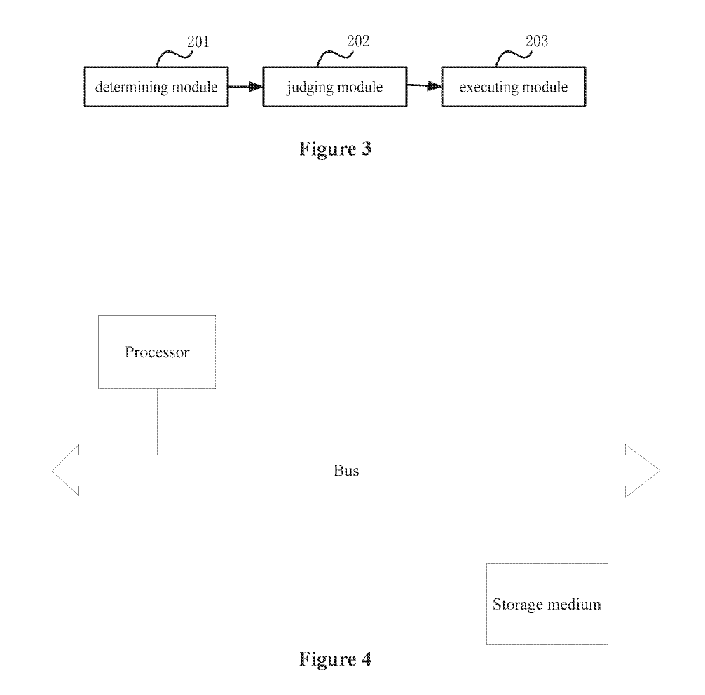

Correspondingly, a device for message prompting is provided according to an embodiment of the present disclosure. As shown in FIG. 2, the device includes: a determining module 201, a judging module 202 and an executing module 203.

The determining module 201 is used to, receive a dialling instruction inputted by a calling user for establishing a voice communication, and determine, based on the received dialling instruction, an identity of a called user to perform the voice communication.

The identity of the called user to perform the voice communication may be a SIM number of the called user, an instant communication number, or a part of the SIM number, etc., which is not limited specifically here.

The judging module 202 is used to judge whether a message corresponding to the identity of the called user to perform the voice communication is included in an unread message.

The executing module 203 is used to display prompt information, when it is judged that the message corresponding to the identity of the called user to perform the voice communication is included in the unread message.

Specifically, the judging module 202 is further used to judge whether an information prompting function for the unread message is enabled.

Optionally, the device for message prompting further includes a receiving module, which is used to receive an operation instruction sent by the calling user.

The operation instruction received by the receiving module includes at least one of: a message reading instruction, a dialling continuing instruction, a dialling abandoning instruction, and a message replying instruction.

If the operation instruction includes a message reading instruction, the executing module is further used to conceal the prompt information: upon reception of the message reading instruction, and display the unread message to the calling user.

If the operation instruction includes a dialling continuing instruction, the executing module is further used to execute the dialling instruction to establish a voice communication upon reception of the dialling continuing instruction.

If the operation instruction includes a dialling abandoning instruction, the executing module is further used to conceal the prompt information upon reception of the dialling abandoning instruction.

If the operation instruction includes a message replying instruction, the executing module is further used to display an operation interface for message replying upon reception of the message replying instruction.

It should be understood to those skilled in the art that, the embodiments of the present disclosure may be provided as methods, devices (apparatuses), or computer program products. Thus, the present disclosure may be implemented with hardware embodiments, software embodiments, or software-hardware combined embodiments. Further, the present disclosure may be embodied as a computer program product which is implemented on one or more computer available storage media (including, but not limited to, a disk storage, a CD-ROM, an optical storage, and so forth) having computer-usable program code stored therein.

The present disclosure has been described with reference to the flow charts and/or block diagrams of the method, device (apparatus) and computer program product according to the embodiments of the present disclosure. It should be understood that computer program instructions may be used to implement each of the work flows and/or blocks in the flow charts and/or the block diagrams, and a combination of the work flows and/or blocks in the flow charts and/or the block diagrams. These computer program instructions may be provided to a processor of a common computer, a dedicate computer, an embedded processor or any other programmable data processing devices to create a machine, so that instructions executable by the processor of the computer or the other programmable data processing devices may create a device to achieve the functions assigned in one or more work flows in the flow chart and/or one or more blocks in the block diagram.

These computer program instructions may also be stored in a computer readable storage that may guide the computer or the other programmable data processing devices to function in a certain way, so that the instructions stored in the computer readable storage may create a product including an instruction unit which achieves the functions assigned in one or more flows in the flow chart and/or one or more blocks in the block diagram.

These computer program instructions may also be loaded in the computer or the other programmable data processing devices, so that a series of operation steps are executed on the computer or the other programmable devices to create processes achieved by the computer. Therefore, the instructions executed in the computer or the other programmable devices provide the steps for achieving the function assigned in one or more flows in the flow chart and/or one or more blocks in the block diagram.

Although preferred embodiments of the present disclosure have been described, additional changes and modifications to these embodiments can be made by those skilled in the art once they learn of the basic inventive concepts. Therefore, it is intended that the appended claims shall be construed to include both the preferred embodiments and all such changes and modifications which fall within the scope of the present disclosure.

It will be apparent to those skilled in the art that various modifications and variations can be made to the present invention without departing from the spirit and scope of the present disclosure. Thus, it is intended that the present disclosure covers modifications and variations of present disclosure provided they come within the scope of the claims of the present disclosure and equivalent technique thereof.

1. A method for message prompting, comprising:
receiving a dialling instruction inputted by a calling user for establishing a voice communication, and determining, based on the received dialling instruction, an identity of a called user to perform the voice communication;
judging whether a message corresponding to the identity of the called user to perform the voice communication is included in an unread message; and
displaying prompt information, when it is judged that the message corresponding to the identity of the called user to perform the voice communication is included in the unread message.

2. The method for message prompting according to claim 1, wherein before the step of receiving a dialling instruction inputted by a calling user for establishing a voice communication, the method further comprises:
judging whether an information prompting function for the unread message is enabled.

3. The method for message prompting according to claim 1, wherein after the step of displaying prompt information, the method further comprises:
receiving an operation instruction sent by the calling user.

4. The method for message prompting according to claim 3, wherein the operation instruction comprises a message reading instruction, and the method for message prompting further comprises:
concealing the prompt information upon reception of the message reading instruction, and displaying the unread message to the calling user.

5. The method for message prompting according to claim 3, wherein the operation instruction comprises a dialling continuing instruction, and the method for message prompting further comprises:
executing the dialling instruction to establish the voice communication upon reception of the dialling continuing instruction.

6. The method for message prompting according to claim 3, wherein the operation instruction comprises a dialling abandoning instruction, and the method for message prompting further comprises:
concealing the prompt information upon reception of the dialling abandoning instruction.

7. The method for message prompting according to claim 3, wherein the operation instruction comprise a message replying instruction, and the method for message prompting further comprises:
displaying an operation interface for message replying upon reception of the message replying instruction.

8. A device for message prompting, comprising:
a determining module, configured to receive a dialling instruction inputted by a calling user for establishing a voice communication, and determine, based on the received dialling instruction, an identity of a called user to perform the voice communication;
a judging module, configured to judge whether a message corresponding to the identity of the called user to perform the voice communication is included in an unread message; and
an executing module, configured to display prompt information when the judging module judges that the message corresponding to the identity of the called user to perform the voice communication is included in the unread message.

9. The device for message prompting according to claim 8, wherein the judging module is further configured to judge whether an information prompting function for the unread message is enabled.

10. The device for message prompting according to claim 8, further comprising:
a receiving module, configured to receive an operation instruction sent by the calling user.

11. The device for message prompting according to claim 10, wherein the operation instruction comprises a message reading instruction; and
the executing module is further configured to, conceal the prompt information upon reception of the message reading instruction, and display the unread message to the calling user.

12. The device for message prompting according to claim 10, wherein the operation instruction comprises a dialling continuing instruction; and
the executing module is further configured to execute the dialling instruction to establish the voice communication upon reception of the dialling continuing instruction.

13. The device for message prompting according to claim 10, wherein the operation instruction comprises a dialling abandoning instruction; and
the executing module is further configured to conceal the prompt information upon reception of the dialling abandoning instruction.

14. The device for message prompting according to claim 10, wherein the operation instruction comprises a message replying instruction; and
the executing module is further configured to display an operation interface for message replying upon reception of the message replying instruction.

15. A device for message prompting, comprising one or more processors and a storage medium which stores therein computer-readable operation instructions, wherein the computer-readable operation instructions, when being executed by the one or more processors, cause the one or more processors to:
receive a dialling instruction inputted by a calling user for establishing a voice communication, and determine, based on the received dialling instruction, an identity of a called user to perform the voice communication;
judge whether a message corresponding to the identity of the called user to perform the voice communication is included in an unread message; and
display prompt information when it is judged that the message corresponding to the identity of the called user to perform the voice communication is included in the unread message.

16. The method for message prompting according to claim 4, wherein the operation instruction comprises a dialling continuing instruction, and the method for message prompting further comprises:
executing the dialling instruction to establish the voice communication upon reception of the dialling continuing instruction.

17. The method for message prompting according to claim 4, wherein the operation instruction comprises a dialling abandoning instruction, and the method for message prompting further comprises:
concealing the prompt information upon reception of the dialling abandoning instruction.

18. The method for message prompting according to claim 4, wherein the operation instruction comprise a message replying instruction, and the method for message prompting further comprises:
displaying an operation interface for message replying upon reception of the message replying instruction.

19. The device for message prompting according to claim 11, wherein the operation instruction comprises a dialling continuing instruction; and
the executing module is further configured to execute the dialling instruction to establish the voice communication upon reception of the dialling continuing instruction.

20. The device for message prompting according to claim 11, wherein the operation instruction comprises a dialling abandoning instruction; and
the executing module is further configured to conceal the prompt information upon reception of the dialling abandoning instruction.
